(19) United States
(12) Patent Application Publication
(10) Pub. No.: US 2004/0018474 A1
(43) Pub. Date: Jan. 29, 2004

(54) Adult/child system and method for learning life experiences and good habits and activities and knowledge

(76) Inventor: Elaine D'Ippolito, Peoria, AZ (US)

Correspondence Address: DONALD W. MEEKER, PATENT AGENT, 924 EAST OCEAN FRONT, SUITE #E, NEWPORT BEACH, CA, 92661, US

(21) Appl. No.: 10/205,652

(22) Filed: Jul. 25, 2002

(51) Int. Cl. G09B 19/00

(52) U.S. Cl. 434/236; 434/362

(57) ABSTRACT

An introductory adult set of instructions provide's background information and directions for an adult to apply a step-by-step life experiences and good habits and activities and knowledge learning program for a child. Exercises and activities are performed by the child as instructed by the adult. Each exercise and activity includes an adult guide for when, how, and why to apply them. A book, workbook, e-book, video, sound recording, computer program or any other desired media can be used. Steps in the life experiences and good habits and activities and knowledge learning program include discovery, interest, attitude, motivation, vicarious experience, experimentation, practice, and learning and mastery of the life experiences and good habits and activities and knowledge.

### BACKGROUND OF THE INVENTION

1. Field of the Invention

The present invention relates to training programs and in particular to a comprehensive life experiences and good habits and activities and knowledge learning and attitude adjustment training system for both parents and children employing a wide variety of interactive exercises and activities to teach an adult how to administer the system and provide for the child a comprehensive developmental process for developing a positive attitude toward life experiences and good habits and activities and knowledge, training in learning how to perform the life experiences and good habits and activities and knowledge, exercises in simulating the life experiences and good habits and activities and knowledge and working vicariously with surrogates in a variety of media, and actual practice of the life experiences and good habits and activities and knowledge, including a performance feedback and reward system, all with integrated instructions and directions for the adult for each exercise and activity.

2. Description of the Prior Art

Learning in young children is a complex activity involving observations, attitudes, desire, experimentation, trial and error, feedback, practice, and strong direction among other things. The learning process can be a challenge for the children doing the learning as well as for the adults doing the teaching.

Adults need to acquire the skills and knowledge and be supplied with appropriate materials to help a child through the natural steps of the learning process by guiding the child, nurturing the child, and helping the child acquire emotional, psychological, and physical skills in adapting to and learning life experiences and good habits and activities and knowledge with positive feedback and encouragement and intervention or nonintervention at appropriate times.

Often the adult, such as a parent who is not trained in teaching methodologies, child psychology, and the steps of the natural learning process, requires assistance in knowing which kind of learning exercise or activity to present, when and how to present it, what to look for to know if it is working, and how to respond to the child during the learning process.

Children need to be nurtured and guided through the natural step-by-step process of discovering the life experiences and good habits and activities and knowledge to be learned, developing a positive attitude about the life experiences and good habits and activities and knowledge, becoming interested in the life experiences and good habits and activities and knowledge and observing the life experiences and good habits and activities and knowledge performed by others, engaging vicariously in the life experiences and good habits and activities and knowledge through models, experimenting with the life experiences and good habits and activities and knowledge in minor and safe ways, and actually trying the life experiences and good habits and activities and knowledge through repetition and practice with a developmental feedback and evaluation system to recognize success and encourage modifications to perfect the life experiences and good habits and activities and knowledge.

Learning some activities is especially troublesome, requiring substantial amounts of time and effort and emotional exertion for both a parent and child in the process of the child becoming proficient in life experiences and good habits and activities and knowledge. Potty training is a particularly difficult learning experience fraught with embarrassment, social stigma, psychological issues, attitudes about body and retention, and many other issues. While the present discussion will center around this particularly prolonged and difficult training activity for both the child and the parent or other adult involved, it is only one example of the many life experiences and good habits and activities and knowledge learning situations to which the present invention may be applied.

While there are many patents on training methods and systems, including those for potty training, using a wide variety of types of models and employing printed material and activities, none are comprehensive in providing a thorough training program for an adult to administer the training as well as a strong psychological and emotional attitude component to the training in a developmental step-by-step approach.

U.S. Pat. No. 6,250,929 issued Jun. 26, 2001 to Kolb, provides a method for improving the effectiveness of toilet training using a progress scale with questions regarding toilet training learned skills with response values to evaluate levels or stages of toilet training with recommendations for improving the effectiveness of the training based on the stage and the skill.

U.S. Pat. No. 6,203,327, issued Mar. 20, 2001 to Ottrando, shows a toilet training system using a board with a pre-printed path made up of step spaces and reward goal spaces with removable marks made on the board to indicate progress for each mark and setbacks by removing marks.

U.S. Pat. No. 5,725,382, issued Mar. 10, 1998 to Walter, claims a self-contained interactive toilet training kit for children and caregivers that includes training pants, interactivity devices and activity devices for encouraging the child in toilet training including learning graphics applied to the kit container.

U.S. Pat. No. 5,387,107, issued Feb. 7, 1995 to Gunter, describes a personalized interactive storybook and method of teaching a reader a desired behavior pattern with text referring to the desired behavior and illustrations, which may be modified to include a picture of the child, related to the carrying out of the desired behavior. A caregiver may read the stories in the book while the child sees him or herself in a picture attached to the book acting out the behavior in the stories.

U.S. Pat. No. 2,946,137, issued Jan. 26, 1960 to Worth, discloses a child's story book with shiftable pictures using cut-out stickers that a child can place in different positions and on different pages in the book.

U.S. Pat. No. 5,577,915, issued Nov. 26, 1996 to Feldman, indicates a motivational task tracking device that organizes activities into categories and provides a graphic incentive system for their performance with cards representing activities placed on a chart to indicate progress.

U.S. Pat. No. 5,951,298, issued Sep. 14, 99 to Werzberger, puts forth an interactive coordinated book assembly with pages having instructions for activities with a key word or image related to the life experiences and good habits and activities and knowledge and using a visual image associated with each activity and a code to indicate age or competency level. The activity “areas” in the book may be covered up, as by a flap of paper or sliding tab, and would have to be uncovered to carry out the activity. Imprinted cards may also be used.

There is a need for a thorough step-by-step training program and guide for an adult to administer the training as well as a need for a training program with a strong psychological and emotional attitude component to the training. and a complete step-by step natural progression through the stages of discovery, interest and attitude development, modeling, vicarious participation, experimentation, feedback, and rewards.

### SUMMARY OF THE INVENTION

An object of the present invention is to provide a natural training program to help a child and guide a child through every step of the process of learning life experiences and good habits and activities and knowledge, starting with discovery, developing a positive attitude and interest, observing, vicariously experiencing, experimenting with, getting positive feedback, rewards, redirections, and ultimate skills for successful mastery in the life experiences and good habits and activities and knowledge, following through until the life experiences and good habits and activities and knowledge become wellformed habits the child will embrace and /or accept as his or her own independent behavior, through practice and repetition of the life experiences and good habits and activities and knowledge, instilling, encouraging and developing the child's own internal desires to continue to perform the life experiences and good habits and activities and knowledge acquiring exercises with the intent that the child form a good habit of the desired the life experiences and good habits and activities and knowledge the parent is shaping, thereby transferring parental motivation to the child using positive rewards and self-esteem building techniques to continue to perform the life experiences and good habits and activities and knowledge applications.

A related object of the present invention is to provide the adult parent or other person teaching the child with a wide variety of ways and ideas to motivate a child to help initiate interest as well as maintain interest in continuing to practice and master the life experiences and good habits and activities and knowledge.

Another object of the present invention is to provide complete instructions for an adult to administer the comprehensive natural developmental program for learning an attitude, interest, and skill in performing the life experiences and good habits and activities and knowledge, evaluating the life experiences and good habits and activities and knowledge, providing feedback and intervention or nonintervention at appropriate times to assist in helping the child master the life experiences and good habits and activities and knowledge.

One more object of the present invention is to provide a series of step by step fun and involving interactive activities and exercises and simulations and modeling and all of the materials necessary to go through the process of accommodating, accepting, being interested in, and participating in the life experiences and good habits and activities and knowledge until they are mastered.

An additional object of the present invention is to combine an adult training program and step-by-step guide to accompany each of the child activities and exercises and simulations in any desired presentation format including of a book, a workbook, a magazine, an electronic book, a computer program, a recording and retrieval device, a visual recording, a sound recording, a multi-media device, an electronic game, an internet web site, a combined visual and sound recording, live interpersonal multimedia presentations including classroom activities, seminars and camps, or any other desired media employing a wide variety of types of interactive exercises and activities using drawing and coloring, cutouts, models, stickers, charts, calendars, certificates of achievement, reward recipes and formulas, songs, and other activities and exercises that encourage the child to want to learn and engage in the life experiences and good habits and activities and knowledge and experiment with them and actually master them.

A related object of the present invention is to provide the necessary assessing readiness and parent observation to minimize stress in the learning-teaching process for the parent and maximize motivation in the child.

A still further object of the present invention is to provide training classes for both the adult and the child, including training camps.

Yet another object of the present invention is to provide parents with the sort of information they will need to not only foster the development of the life experiences and good habits and activities and knowledge, but also to avoid possible pitfalls and common social or emotional drawbacks while a child learns and adopts these new and complex concepts. Such information is not readily available elsewhere to parents and in the past they often either had to “wing it” or spend much time and energy looking for answers to setbacks or complications.

In brief, a comprehensive training system and natural step-by-step method for learning and developing a positive attitude toward life experiences and good habits and activities and knowledge includes a training system and step-by-step guide for an adult to use in administering interactive exercises and activities for a child to go through a natural cycle of learning and acquiring the ability and desire to perform life experiences and good habits and activities and knowledge including discovery of the life experiences and good habits and activities and knowledge, developing a positive attitude toward and interest in them, observing them, vicariously experiencing them, experimenting with them through repetition and practice, getting positive feedback, rewards, redirections, and developing ultimate skills for success.

A beginning adult introduction program accompanying the child activity and exercise program provides an overview for the adult to learn how, when and why to apply each activity and exercise. In addition, each exercise or activity for the child (primarily visual, pictorial, or object oriented for pre-literate toddlers) is provided with a guiding instruction (usually written or spoken) for the adult concerning when and how to administer each exercise and activity and what to look for in the child's attitude and behavior to judge the progress in the child's developing a positive attitude toward and learning the life experiences and good habits and activities and knowledge.

The system and method can be applied in many different types of media including of a book, a workbook, a magazine, an electronic book, a computer program, a visual recording, a sound recording, a multi-media device, a recording and retrieval device, an electronic game, an internet web site, a combined visual and sound recording, live interpersonal multimedia presentations including classroom activities, seminars and camps, or any other desired media.

In one application, training workbooks (printed or electronic) provide instructional material and a step-by-step guide in visual words for training adults in administering the life experiences and good habits and activities and knowledge learning experience and providing feedback and intervention and nonintervention, including an adult introductory section at the beginning and instructional guidance with every exercise and life experiences and good habits and activities and knowledge to be performed by the child. Included are a wide variety of interactive materials and exercises for the child using different media, such as stickers, charts, calendars, certificates of achievement, drawing and coloring pages, reward recipes and formulas, cut-out hats, songs, and other activities that encourage the child to want to learn and engage in the life experiences and good habits and activities and knowledge and have a positive feeling about the life experiences and good habits and activities and knowledge to overcome the psychological barriers to engaging in the life experiences and good habits and activities and knowledge.

By coordinating the caregiver's instructional guide along with each of the child's activities and exercises, the adult knows exactly when and how to administer the life experiences and good habits and activities and knowledge, why the life experiences and good habits and activities and knowledge or exercise was developed based on educational principles, and what to look for before and after each one helping the child to go through the natural steps of discovering, becoming interested in, developing a positive attitude about, vicariously experiencing, experimenting with, practicing, learning and mastering life experiences and good habits and activities and knowledge.

The system and method teaches and encourages the child, acclimates the child to feel comfortable about the life experiences and good habits and activities and knowledge, moves the child forward to engage in the life experiences and good habits and activities and knowledge, rewards the child for successes, and makes comfortable provisions for minor setbacks to keep the life experiences and good habits and activities and knowledge moving forward. The comprehensive training system and method covers every natural step of learning and development to master life experiences and good habits and activities and knowledge using a wealth of diverse interactive activities and exercises and progress indicators and rewards and the related physical interactive media for carrying out these things along with the comprehensive training in teaching and guiding the adult in administering the system and method.

An advantage of the present invention is that it is comprehensive in instructing and guiding an adult to walk a child through a natural progression of developing interest in and a positive attitude toward life experiences and good habits and activities and knowledge and then trying the life experiences and good habits and activities and knowledge through the steps of vicariously experiencing the life experiences and good habits and activities and knowledge, experimenting with the life experiences and good habits and activities and knowledge, practicing the life experiences and good habits and activities and knowledge, and mastering the life experiences and good habits and activities and knowledge with appropriate feedback, rewards, redirections, and interventions and noninterventions by the adult.

Another advantage of the present invention is that it provides a fun and natural way for an adult and child to go through the process of helping the child appreciate, learn, and master life experiences and good habits and activities and knowledge.

An additional advantage of the present invention is that it provides a means for both the adult and the child to feel comfortable about the process.

A further advantage of the present invention is that it minimizes stress in the learning-teaching process for the parent and maximizes motivation in the child.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a flow diagram view showing the training system and steps of the method for learning life experiences and good habits and activities and knowledge;

FIG. 2 is a plan view of one exercise/life experiences and good habits and activities and knowledge related to discovery and interest from the training system and method of FIG. 1; FIG. 3 is a plan view of another exercise/life experiences and good habits and activities and knowledge related to attitude and motivation from the training system and method of FIG. 1.

### BEST MODE FOR CARRYING OUT THE INVENTION

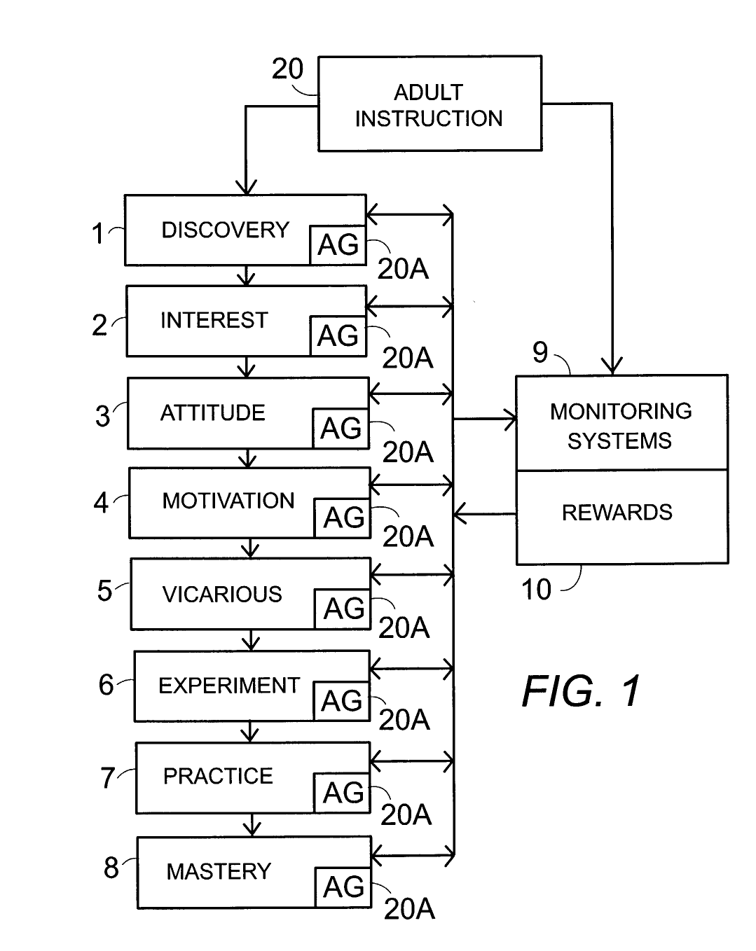

In FIG. 1, a comprehensive training system for an adult to administer and a child to learn life experiences and good habits and activities and knowledge in a natural stepby-step life experiences and good habits and activities and knowledge learning program including helping the child discover and develop a positive attitude toward the life experiences and good habits and activities and knowledge comprises a set of instructions 20 for an adult and a set of step-by-step exercises and activities 1-8 for a child including a guide 20A for the adult accompanying each of the exercises and activities.

The set of instructions 20 for an adult explain a step-by-step life experiences and good habits and activities and knowledge learning program to the adult and provide the adult with a methodology for administering the life experiences and good habits and activities and knowledge learning program including a series of ordered steps for observing and working with the child to assist the child in advancing through a series of natural stages associated with learning the life experiences and good habits and activities and knowledge. Adult or parent instructions also include information on how to avoid problems and redirect children away from learning “wrong” or ineffective ways of adopting the life experiences and good habits and activities and knowledge while learning. For example in potty training: some kids develop toilet fears after they see their mother frustrated, angry and dealing with an overflowing toilet. Some kids are afraid to get poop on their hands and may be more fearful of this when parents react that way to it as well. The present inventive system provides lots of ways to deal with the common problem of regression, where a kid is fully trained, then starts not using the toilet, going in their clothes, going in a corner of a closet, or other undesirable behavior. For speech skills: adults learn to deal with children who have “cute” speech impediments like a lisp or mispronouncing the letter “L” by saying words such as “wittle” instead of “little”. While that is cute and endearing, it should really be dealt with and worked on as early as possible to avoid forming strong bad habits and real speech problems later. The present system provides a plethora of motivational ideas for adults to coax and guide a child to engage in and practice “good” habits and behaviors as the child becomes bored or less motivated to embrace the life experiences and good habits and activities and knowledge using current or more familiar tactics.

The set of interactive exercises and activities 1-8 to be performed by the child to move through the natural learning stages of discovering the life experiences and good habits and activities and knowledge 1, becoming interested in the life experiences and good habits and activities and knowledge 2, developing a positive attitude about the life experiences and good habits and activities and knowledge 3, developing motivation to engage in the life experiences and good habits and activities and knowledge 4, vicariously experiencing the life experiences and good habits and activities and knowledge 5, experimenting with the life experiences and good habits and activities and knowledge 6, practicing the life experiences and good habits and activities and knowledge 7, learning and mastering the life experiences and good habits and activities and knowledge 8, and all the while monitoring the learning process with at least one monitoring system 9 and being rewarded with at least one reward system 10 for each step of the natural learning stages.

A guide 20A for the adult accompanies each of the exercises and activities instructing the adult in when and why and how to administer each of the exercises and activities and what to look for in the behavior and performance of the child relative to the stages of learning the life experiences and good habits and activities and knowledge.

The set of interactive exercises and activities 1-8 includes activities such as wearing clothing associated with the life experiences and good habits and activities and knowledge such as the selecting and wearing of underwear as directed by the adult guide 20A of FIG. 3, used in potty training to serve as a way to change the child's attitude about potty life experiences and good habits and activities and knowledge by selecting a favorite character on the underwear to enhance the attitude of independence and pride in wearing the underwear and also to provide motivation for learning the potty training so as not to soil the underwear. Other activities include using equipment associated with the life experiences and good habits and activities and knowledge, cutting out and wearing articles associated with the life experiences and good habits and activities and knowledge, naming games associated with the life experiences and good habits and activities and knowledge, playing with items related to the life experiences and good habits and activities and knowledge, using words related to the life experiences and good habits and activities and knowledge, singing songs related to the life experiences and good habits and activities and knowledge, making and wearing stickers associated with the life experiences and good habits and activities and knowledge, and any other activities to help carry out the steps of the comprehensive training system and method for learning life experiences and good habits and activities and knowledge 1-8.

The set of interactive exercises and activities includes exercises such as drawing and coloring pages related to the life experiences and good habits and activities and knowledge such as coloring the undies in FIG. 3 to improve the child's attitude about learning potty training by thinking about wearing a favorite pair of underwear as a part of learning the potty training life experiences and good habits and activities and knowledge and serving as motivation to learn the life experiences and good habits and activities and knowledge and not soil the underwear. The exercise for the child to improve attitude and motivation 3 and 4 is shown in the top of FIG. 3 appropriate to a pre-literate toddler with pictures and the fun activity of coloring, and the related adult guide 20A in words at the bottom of FIG. 3.

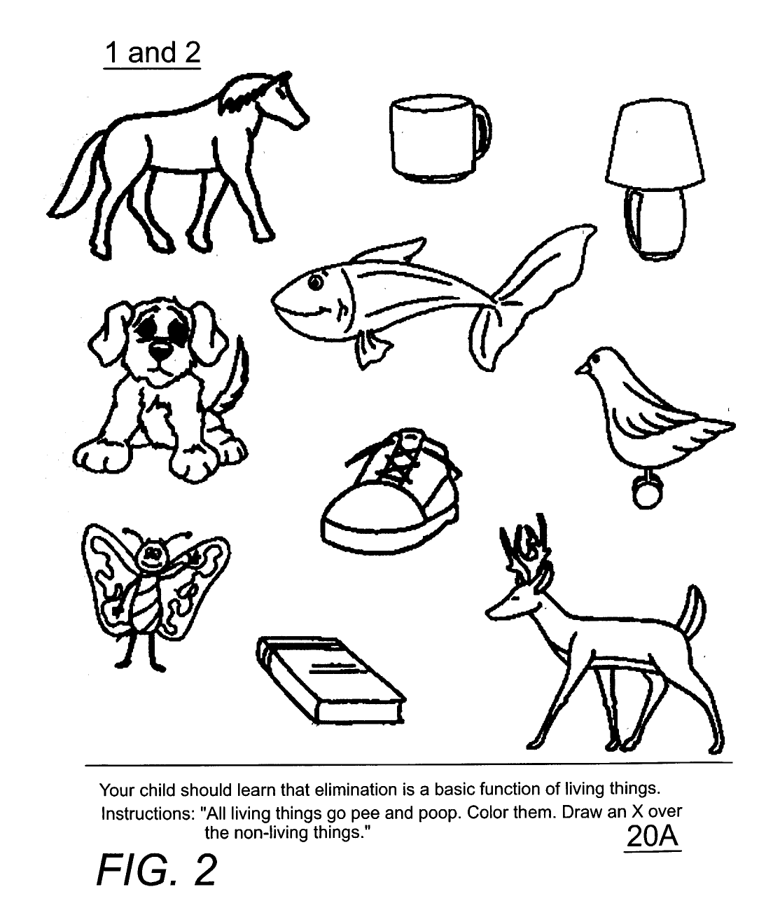

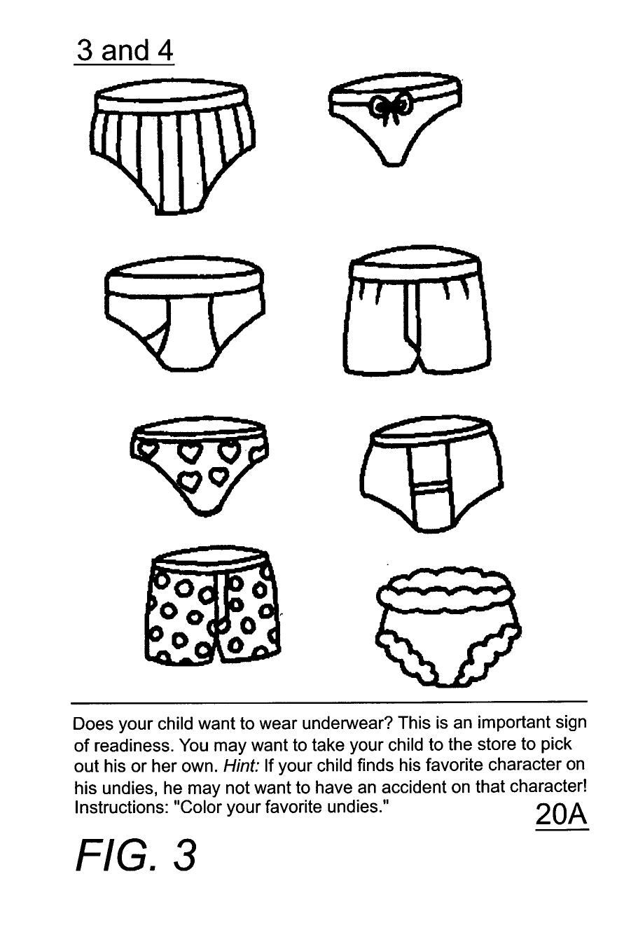

In FIG. 2, the steps of discovery 1 of and interest 2 in the life experiences and good habits and activities and knowledge, in this case potty training, are explored by the child in a fun exercise using coloring and drawing to discover and become interested in the relevant knowledge that all living things eliminate. The adult guide 20A built into the exercise instructs the adult in the importance of the exercise that “Your child should learn that elimination is a basic function of living things.” And it further provides the instructions the adult can give the child that “All living things go pee and poop. Color them. Draw an X over the non-living things.”

Other exercises include making stickers associated with the life experiences and good habits and activities and knowledge, applying stickers related to the life experiences and good habits and activities and knowledge, matching pictures related to the life experiences and good habits and activities and knowledge, connecting the dots pictures related to the life experiences and good habits and activities and knowledge, connecting an image of a child to the life experiences and good habits and activities and knowledge through a pattern, counting images related to the life experiences and good habits and activities and knowledge, and any other exercises to help carry out the steps of the comprehensive training system and method for learning life experiences and good habits and activities and knowledge 1-8.

The training system and method further comprises one or more monitoring systems 9, which could be developed and used by both the child and the adult, for monitoring the progress of learning the life experiences and good habits and activities and knowledge, such as a calendar progress chart, a bar chart, a block chart, a chart with openable doors, a list of successful behavior associated with each step of the process, a list of people to tell about each success, a child success diary, an adult success diary, a progress sticker poster, and any other monitoring systems and methods to help carry out the steps of the comprehensive training system and method for learning life experiences and good habits and activities and knowledge 1-8.

In FIG. 3 in the adult guide 20A built into the exercise, part of the monitoring system consists of guiding the adult in watching for signs of how the child is progressing through the process of learning the life experiences and good habits and activities and knowledge and to guide the adult in next steps to take based on the process of learning the life experiences and good habits and activities and knowledge, such as in potty training asking the adult “Does you child want to wear underwear?” and observing that “This is an important sign of readiness.” The adult then presents the activities and exercises related to the sign of readiness for the life experiences and good habits and activities and knowledge to monitor the level of readiness and proceed according to the readiness of the child for the life experiences and good habits and activities and knowledge. The assessing readiness and parent observation is meant to minimize stress in the learning-teaching process for the parent and maximize motivation in the child.

The training system and method further comprises a reward system 10 for providing rewards and subsequent motivation based on the feedback from the monitoring system 9 to acknowledge and appreciate the progress being made by the child and to provide further incentive with rewards including certificates of achievement, wearable reward stickers, a reward sticker poster, reward recipes and formulas, and any other reward systems and methods to help carry out the steps of the comprehensive training system and method for learning life experiences and good habits and activities and knowledge 1-8.

The training system and method of the present invention may be carried out in a variety of media for implementing the system and method, including of a book, a workbook, a magazine, an electronic book, a computer program, a visual recording, a sound recording, a multi-media device, a recording and retrieval device, an electronic game, an internet web site, a combined visual and sound recording, live interpersonal multimedia presentations including classroom activities, seminars and camps, and any other media to help carry out the steps of the comprehensive training system and method for learning life experiences and good habits and activities and knowledge 1-8.

In use, the comprehensive training method for an adult to administer and a child to learn life experiences and good habits and activities and knowledge in a natural stepby-step life experiences and good habits and activities and knowledge learning program including helping the child discover and develop a positive attitude toward the life experiences and good habits and activities and knowledge comprises the steps of instructing the adult, providing exercises and activities for the adult to administer to the child, providing a guide for the adult in each exercise and activity on how, when and why to apply it, and continual monitoring and rewards through all of the steps.

The step of providing a set of instructions for an adult explains a step-by-step life experiences and good habits and activities and knowledge learning program to the adult and provide the adult with a methodology for administering the life experiences and good habits and activities and knowledge learning program including a series of ordered steps for observing and working with the child to assist the child in advancing through a series of natural stages associated with learning the life experiences and good habits and activities and knowledge.

The step of providing a set of interactive exercises and activities to be performed by a child moves the child through the natural learning stages of discovering the life experiences and good habits and activities and knowledge, becoming interested in the life experiences and good habits and activities and knowledge, developing a positive attitude about the life experiences and good habits and activities and knowledge, developing motivation to engage in the life experiences and good habits and activities and knowledge, vicariously experiencing the life experiences and good habits and activities and knowledge, experimenting with the life experiences and good habits and activities and knowledge, practicing the life experiences and good habits and activities and knowledge, learning and mastering the life experiences and good habits and activities and knowledge, and being rewarded for each step of the natural learning stages.

The step of providing a guide for the adult accompanying each of the exercises and activities instructs the adult in when, why, and how to administer each of the exercises and activities and what to look for in the behavior and performance of the child relative to the stages of learning the life experiences and good habits and activities and knowledge.

Throughout the training method one or more monitoring systems are implemented to monitor the progress of learning the life experiences and good habits and activities and knowledge including making a calendar progress chart, making a bar chart, making a block chart, making a chart with openable doors, making a list of successful behavior associated with each step of the process, making a list of people to tell about each success, making a child success diary, making an adult success diary, making a progress sticker poster, and any other monitoring methods for helping to carry out the steps of the comprehensive training system and method for learning life experiences and good habits and activities and knowledge 1-8.

Throughout the training method one or more reward systems based on the monitoring systems provide recognition and motivation for the child including giving certificates of achievement, providing wearable reward stickers, creating a reward sticker poster, making reward recipes and formulas, and any other reward methods for helping to carry out the steps of the comprehensive training method for learning life experiences and good habits and activities and knowledge 1-8.

The training method may use any desired media for implementing the method including of a book, a workbook, a magazine, an electronic book, a computer program, a visual recording, a sound recording, a multi-media device, a recording and retrieval device, an electronic game, an internet web site, a combined visual and sound recording, live interpersonal multimedia presentations including classroom activities, seminars and camps, and any other media to help carry out the steps of the comprehensive training system and method for learning life experiences and good habits and activities and knowledge 1-8.

The training system and method may apply to the life experiences and good habits and activities and knowledge learned including any of the life experiences and good habits and activities and knowledge taken from the list of potty training, night toilet training/dryness, proper speech, sleep and relaxation habits, hygiene, grief and sadness, parental turmoil, self esteem, kindness, psychological issues, emotional issues, parent/child relations, overcoming shyness, making friends, manners, chores, nutrition, phonics, math, alphabet, reading, and pre-reading.

It is understood that the preceding description is given merely by way of illustration and not in limitation of the invention and that various modifications may be made thereto without departing from the spirit of the invention as claimed.

What is claimed is:

1. A comprehensive training system for an adult to administer and a child to learn life experiences and good habits and activities and knowledge in a natural step-by-step learning program including helping the child discover and develop a positive attitude toward the life experiences and good habits and activities and knowledge, the system comprising:
a set of instructions for an adult for explaining a step-by-step life experiences and good habits and activities and knowledge learning program to the adult and providing the adult with a methodology for administering the life experiences and good habits and activities and knowledge learning program including a series of ordered steps for observing and working with the child to assist the child in advancing through a series of natural stages associated with learning the life experiences and good habits and activities and knowledge;
a set of interactive exercises and activities to be performed by a child to move through the natural learning stages of discovering the life experiences and good habits and activities and knowledge, becoming interested in the life experiences and good habits and activities and knowledge, developing a positive attitude about the life experiences and good habits and activities and knowledge, developing motivation to engage in the life experiences and good habits and activities and knowledge, vicariously experiencing the life experiences and good habits and activities and knowledge, experimenting with the life experiences and good habits and activities and knowledge, practicing the life experiences and good habits and activities and knowledge, learning and mastering the life experiences and good habits and activities and knowledge, and being rewarded for each step of the natural learning stages;
a guide for the adult accompanying each of the exercises and activities instructing the adult in when and why and how to administer each of the exercises and activities and what to look for in the behavior and performance of the child relative to the stages of learning the life experiences and good habits and activities and knowledge.

2. The training system of claim 1 wherein the set of interactive exercises and activities includes an activity taken from the list of wearing clothing associated with the life experiences and good habits and activities and knowledge, using equipment associated with the life experiences and good habits and activities and knowledge, cutting out and wearing articles associated with the life experiences and good habits and activities and knowledge, playing naming games associated with the life experiences and good habits and activities and knowledge, playing with items related to the life experiences and good habits and activities and knowledge, using words related to the life experiences and good habits and activities and knowledge, singing songs related to the life experiences and good habits and activities and knowledge, playing electronic games related to the life experiences and good habits and activities and knowledge and making and wearing stickers associated with the life experiences and good habits and activities and knowledge.

3. The training system of claim 1 wherein the set of interactive exercises and activities includes an exercise taken from the list of making stickers associated with the life experiences and good habits and activities and knowledge, applying stickers related to the life experiences and good habits and activities and knowledge, matching pictures related to the life experiences and good habits and activities and knowledge, drawing and coloring pages related to the life experiences and good habits and activities and knowledge, connecting the dots pictures related to the life experiences and good habits and activities and knowledge, connecting an image of a child to the life experiences and good habits and activities and knowledge through a pattern, and counting images related to the life experiences and good habits and activities and knowledge.

4. The training system of claim 1 further comprising a monitoring system for monitoring the progress of learning the life experiences and good habits and activities and knowledge consisting of a monitoring system taken from the list of a calendar progress chart, a bar chart, a block chart, a chart with openable doors, a list of successful behavior associated with each step of the process, a list of people to tell about each success, a child success diary, an adult success diary, and a progress sticker poster.

5. The training system of claim 1 further comprising a reward system for motivation taken from the list of certificates of achievement, wearable reward stickers, a reward sticker poster, and reward recipes and formulas.

6. The training system of claim 1 wherein the media for implementing the system comprises a medium taken from the list of a book, a workbook, a magazine, an electronic book, a computer program, a visual recording, a sound recording, a multimedia device, a recording and retrieval device, an electronic game, an internet web site, a combined visual and sound recording, and live interpersonal multimedia presentations including classroom activities, seminars and camps.

7. The training system of claim 1 wherein the life experiences and good habits and activities and knowledge learned include one of the life experiences and good habits and activities and knowledge taken from the list of potty training, night toilet training/dryness, proper speech, sleep and relaxation habits, hygiene, grief and sadness, parental turmoil, self esteem, kindness, psychological issues, emotional issues, parent/child relations, overcoming shyness, making friends, manners, chores, nutrition, phonics, math, alphabet, reading, and pre-reading.

8. A comprehensive training method for an adult to administer and a child to learn life experiences and good habits and activities and knowledge in a natural step-by-step life experiences and good habits and activities and knowledge learning program including helping the child discover and develop a positive attitude toward the life experiences and good habits and activities and knowledge, the method comprising:
the step of providing a set of instructions for an adult to explain a step-by-step life experiences and good habits and activities and knowledge learning program to the adult and provide the adult with a methodology for administering the life experiences and good habits and activities and knowledge learning program including a series of ordered steps for observing and working with the child to assist the child in advancing through a series of natural stages associated with learning the life experiences and good habits and activities and knowledge;
the step of providing a set of interactive exercises and activities to be performed by a child to move through the natural learning stages of discovering the life experiences and good habits and activities and knowledge, becoming interested in the life experiences and good habits and activities and knowledge, developing a positive attitude about the life experiences and good habits and activities and knowledge, developing motivation to engage in the life experiences and good habits and activities and knowledge, vicariously experiencing the life experiences and good habits and activities and knowledge, experimenting with the life experiences and good habits and activities and knowledge, practicing the life experiences and good habits and activities and knowledge, learning and mastering the life experiences and good habits and activities and knowledge, and being rewarded for each step of the natural learning stages;
the step of providing a guide for the adult accompanying each of the exercises and activities instructing the adult in when, why, and how to administer each of the exercises and activities and what to look for in the behavior and performance of the child relative to the stages of learning the life experiences and good habits and activities and knowledge.

9. The training method of claim 8 wherein the set of interactive exercises and activities includes the step of performing life experiences and good habits and activities and knowledge taken from the list of wearing clothing associated with the life experiences and good habits and activities and knowledge, using equipment associated with the life experiences and good habits and activities and knowledge, cutting out and wearing articles associated with the life experiences and good habits and activities and knowledge, naming games associated with the life experiences and good habits and activities and knowledge, playing with items related to the life experiences and good habits and activities and knowledge, using words related to the life experiences and good habits and activities and knowledge, singing songs related to the life experiences and good habits and activities and knowledge, and making and wearing stickers associated with the life experiences and good habits and activities and knowledge.

10. The training method of claim 8 wherein the set of interactive exercises and activities includes the step of implementing an exercise taken from the list of making stickers associated with the life experiences and good habits and activities and knowledge, applying stickers related to the life experiences and good habits and activities and knowledge, matching pictures related to the life experiences and good habits and activities and knowledge, drawing and coloring pages related to the life experiences and good habits and activities and knowledge, connecting the dots pictures related to the life experiences and good habits and activities and knowledge, connecting an image of a child to the life experiences and good habits and activities and knowledge through a pattern, and counting images related to the life experiences and good habits and activities and knowledge.

11. The training method of claim 8 further comprising the step of implementing a monitoring system for the progress of learning the life experiences and good habits and activities and knowledge consisting of a monitoring step taken from the list of making a calendar progress chart, making a bar chart, making a block chart, making a chart with openable doors, making a list of successful behavior associated with each step of the process, making a list of people to tell about each success, making a child success diary, making an adult success diary, and making a progress sticker poster.

12. The training method of claim 8 further comprising the step of implementing a reward system for motivation taken from the list of giving certificates of achievement, providing wearable reward stickers, creating a reward sticker poster, and making reward recipes and formulas.

13. The training method of claim 8 wherein the media for implementing the method comprises a medium taken from the list of a book, a workbook, a magazine, an electronic book, a computer program, a visual recording, a sound recording, a multimedia device, a recording and retrieval device, an electronic game, an internet web site, a combined visual and sound recording, and live interpersonal multimedia presentations including classroom activities, seminars and camps.

14. The training method of claim 8 wherein the life experiences and good habits and activities and knowledge learned include one of the life experiences and good habits and activities and knowledge taken from the list of potty training, night toilet training/dryness, proper speech, sleep and relaxation habits, hygiene, grief and sadness, parental turmoil, self esteem, kindness, psychological issues, emotional issues, parent/child relations, overcoming shyness, making friends, manners, chores, nutrition, phonics, math, alphabet, reading, and pre-reading.
